(19) United States
(12) Patent Application Publication
(10) Pub. No.: US 2013/0301070 A1
(43) Pub. Date: Nov. 14, 2013

(54) CHECKING APPARATUS, CONTROL METHOD THEREOF, AND PRINTING APPARATUS

(71) Applicant: CANON KABUSHIKI KAISHA, TOKYO (JP)

(72) Inventor: Kazuya Saisho, Yokohama-shi (JP)

(73) Assignee: CANON KABUSHIKI KAISHA, TOKYO (JP)

(21) Appl. No.: 13/890,120

(22) Filed: May 8, 2013

(30) Foreign Application Priority Data
May 11, 2012 (JP) 2012-109037

(51) Int. Cl. G06T 7/00; H04N 1/00

(52) U.S. Cl. CPC G06T 7/0002; H04N 1/00278
USPC 358/1.13; 382/112

(57) ABSTRACT

There is provided a checking apparatus being capable of readily performing re-printing while reducing an amount of storage for storing print image data to be used for checking processing. A control method for controlling the checking apparatus includes reading an image printed on a sheet by a printing apparatus, storing image data to be compared with the image read by the reading unit in a storage unit, determining whether the image printed on the sheet by the printing apparatus is correct based on the image data obtained by reading the image and the image data stored by the storage unit, judging whether the sheet has been discharged, and controlling deletion of the image data stored in the storage unit based on a determining result and a judging result.

### BACKGROUND OF THE INVENTION

1. Field of the Invention

The present invention relates to a checking apparatus, a control method thereof, and a printing apparatus.

2. Description of the Related Art

Conventionally, in a print industry and a print on demand (POD) market, a checking work for checking whether a print product to be delivered to clients is stained or blurred is not automatically performed, and thus workers manually check the print product. When the print product includes several hundreds of pages, checking all pages meticulously takes an enormous amount of time and work.

Then, as a technique for automatically performing the checking work, a technique for checking the print product by comparing a check image for checking the print product with an image obtained by scanning the print product is known.

Japanese Patent Application Laid-Open No. 2009-222769 discusses an apparatus capable of detecting a stain or a blur and performing re-printing by reading the print product with a scanner and comparing the read image data with original print image data.

However, Japanese Patent Application No. 2009-222769 does not discuss management of the print image data (reference) and the scanned image data after printing and checking are completed.

In an checking apparatus, if, after printing and checking are completed, the print image data and the scanned image data of each page are recorded in a storage device, a great amount of recording capacity is required.

On the other hand, if the read image data and the original print image data are deleted each time the printing and the checking for each page is completed, re-printing cannot be performed, when the stain or the blur is detected. Further, when the re-printing is performed, to check the image to be re-printed, the original print image data (reference) needs to be transferred again from the printing apparatus to the checking apparatus. Particularly, when color printing/checking is performed, the print image has a large data size and a time for transferring the data takes very long, thereby reducing performance of an entire system.

### SUMMARY OF THE INVENTION

The present invention is directed to a checking apparatus.

According to an aspect of the present invention, a checking apparatus includes a reading unit configured to read an image printed on a sheet by a printing apparatus, a storage unit configured to store image data to be compared with the image read by the reading unit, a determining unit configured to determine whether the image printed on the sheet by the printing apparatus is correct based on the image data obtained by reading the image by the reading unit and the image data stored by the storage unit a judging unit configured to judge whether the sheet has been discharged, and a control unit configured to control deletion of the image data stored in the storage unit based on a determination result by the determining unit and a judging result by the judging unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a checking system.

FIG. 2 is a cross-sectional view illustrating an example of a printing system.

FIG. 3 illustrates an image reading operation of an image of a print output product.

FIG. 4 is a block diagram illustrating a configuration of a checking control unit illustrated in FIG. 2.

FIG. 5 is an example illustrating reference image data stored in a storage device.

FIG. 6 is an example illustrating scanned image data stored in the storage device illustrated in FIG. 4.

FIG. 7 illustrates a pixel of interest of the scanned image data.

FIG. 8 illustrates a management method of print image data in a checking system.

FIG. 9 illustrates a management method of the print image data in the checking system.

FIG. 10, composed of FIGS. 10A, 10B and 10C, is a flowchart illustrating a control method of the checking system.

FIG. 11 is a flowchart illustrating a control method of a printing apparatus.

FIG. 12 is a flowchart illustrating a control method of a checking apparatus.

FIG. 13 illustrates a management method of print image data in a checking system.

FIG. 14 illustrates a management method of the print image data in the checking system.

FIG. 15 is a flowchart illustrating a control method of a checking apparatus.

FIG. 16, composed of FIGS. 16A, 16B and 16C, is a flowchart illustrating a control method of the checking system.

### DESCRIPTION OF THE EMBODIMENTS

Various exemplary embodiments, features, and aspects of the invention will be described in detail below with reference to the drawings.

### <Description of System Configuration>

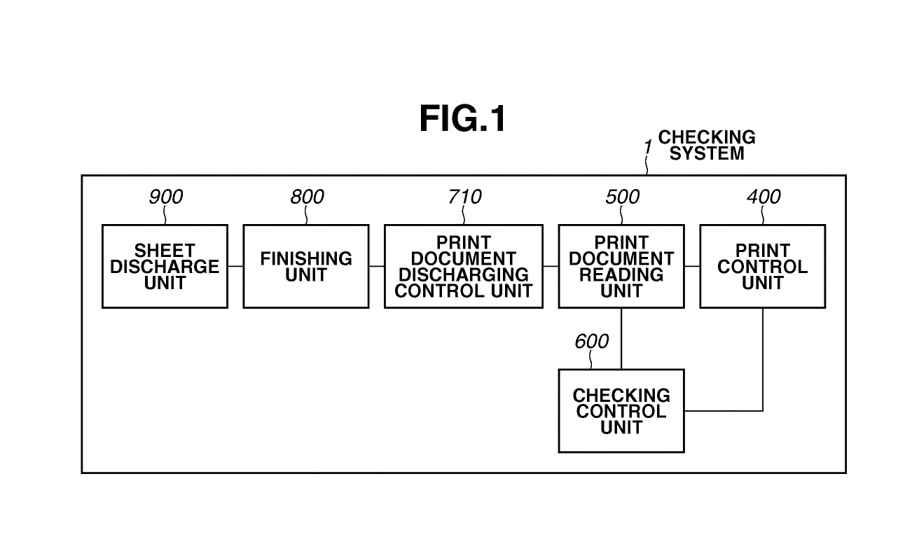

FIG. 1 is a block diagram illustrating a configuration of a checking system according to the present exemplary embodiment. The checking system according to the present exemplary embodiment includes a printing apparatus for performing printing on a sheet, a checking apparatus for checking an image printed thereon, and a sheet discharging apparatus for discharging the checked sheet.

The sheet can be conveyed from the printing apparatus to the checking apparatus, and then from the checking apparatus to the sheet discharging apparatus, and thus checking can be performed in parallel with printing. As illustrated in FIG. 1, a checking system 1 includes a print control unit 400, a print-document reading unit 500, a checking control unit 600, a print-document discharging control unit 710, a finishing unit 800, and sheet discharge unit 900.

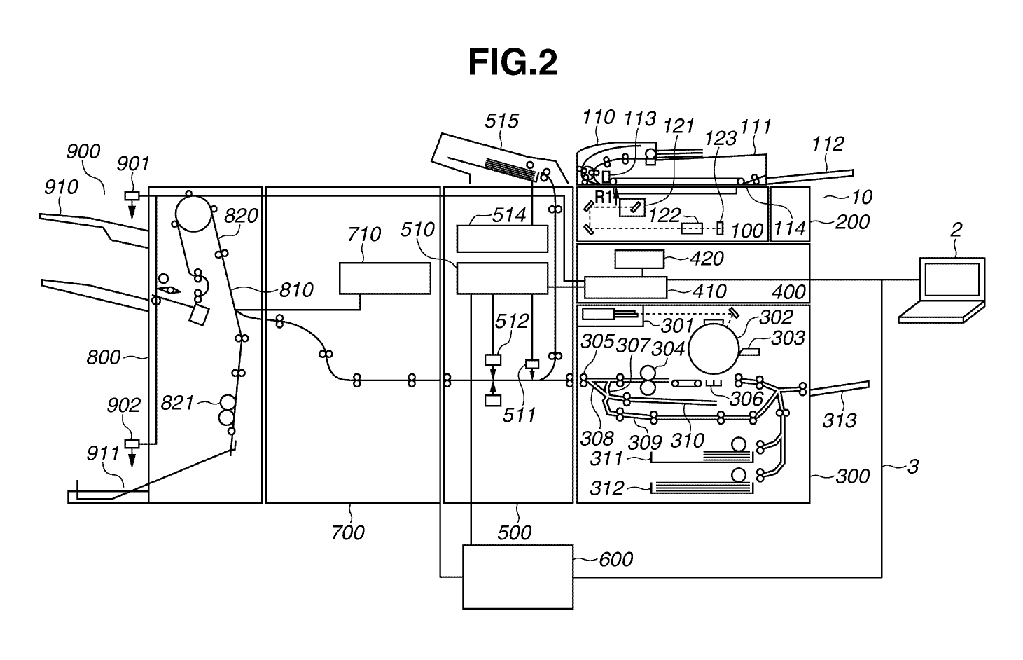

FIG. 2 is a cross-sectional view illustrating an example of a printing system illustrated in FIG. 1.

The printing system includes the printing apparatus, the checking apparatus, and the sheet discharging apparatus. The printing apparatus can communicate with an external general personal computer (PC) 2 via a network 3. Further, the checking apparatus can communicate with the checking control unit 600 via a control line, and also can communicate with the external general PC 2 via the network 3. As illustrated in FIG. 2, a print unit 10 includes an image reading unit 100, an operation unit 200, a printer unit 300, and a print control unit 400. The print control unit 400 includes hardware such as a central processing unit (CPU) for controlling printing processing, a random access memory (RAM), and a read only memory (ROM), and the CPU executes various types of controls by reading and executing a program stored in the ROM.

A user sets a copy job performed by the print unit 10 using the operation unit 200. Further, the user can also set a print job performed by the print unit 10 using the general PC 2. In either case, the user also sets the checking of the print product to the checking control unit 600.

A document conveyance device 110 conveys each one page of documents set on a document tray 111 sequentially from a top page, and further conveys the page to a document positioning glass 114 via a curved path. The image reading unit 100 reads an image of the document conveyed by the document conveyance device 110.

Two types of methods for reading one-sided document are provided. A first method is a document fixed-reading mode in which a rear end of the document is conveyed to a reading position R1 on the document positioning glass 114 and stopped there, and then a scanner unit 121 is moved from left to right to read the document. A second method is a document conveyance reading mode in which the document is conveyed to the reading position R1 at a predetermined reading speed, and then the document is read with the scanner unit 121 fixed at the reading position R1. The document read by either of the above-described two types of methods for reading the one-sided document is discharged to a sheet discharge tray 112.

When the two-sided document is read, the scanner unit 121 reads a front face of the document by either of the two types of methods described above, and an optical unit 113 disposed in the document conveyance device 110 reads a rear face thereof. In the optical unit 113, an image sensor and a light source (not illustrated) are disposed.

Image processing is performed on the image data of the document read by an image sensor 123 via a lens 122, and then the image data is transferred to a printing-apparatus controller unit 410 and stored in a storage device 420. The printing-apparatus controller unit 410 communicates with a printer control unit 301 controlling the printer unit 300, and prints an image based on the image data stored in the storage device 420 onto a sheet. The present exemplary embodiment describes a case where the storage device 420 is formed of a non-volatile storage device such as a hard disk device (HDD), however, the storage device 420 is not limited to the HDD. The printing-apparatus controller unit 410 performs deletion processing of the printed print image data stored in the storage device 420 and re-printing processing based on the flowchart described below.

Further, when page description language (PDL) data is input via the general PC 2, raster image processor (RIP) processing is performed by a RIP unit. RIP data is stored in the storage device 420. The printing-apparatus controller unit 410 communicates with the printer control unit 301 to print an image based on the RIP data onto the sheet.

The printer control unit 301 outputs a laser beam according to an image signal. If a photosensitive drum 302 is irradiated with the laser beam, an electrostatic latent image is formed on the photosensitive drum 302. The electrostatic latent image on the photosensitive drum 302 is developed by a developing device 303, and developer thereon is transferred by a transfer unit 306 onto a sheet fed from either of cassettes 311, 312 and a manual sheet feeding unit 313. The sheet on which the developer has been transferred is led to a fixing unit 304, and then fixing processing of the developer transferred onto the sheet is performed.

The sheet that has passed the fixing unit 304 is once led from a path 307 to a path 310 by a flapper (not illustrated) and, after the rear end of the sheet passes through the path 307, the sheet is switched back to be led to a sheet discharge roller 305 from a path 308.

With this arrangement, the sheet whose face onto which the developer is transferred can be discharged from the printer unit 300 by the sheet discharge roller 305 with its face down. This is referred to as “reversed sheet discharge”. As described above, by discharging the sheet with its face down, the images can be formed in a correct order of the pages from the top page, for example, when the images read from a plurality of documents using the document conveyance device 110 are printed. When the image is formed on a hard sheet such as an overhead projector (OHP) sheet fed from the manually sheet-feeding unit 313, the sheet is not led to the path 307 but discharged from the sheet discharge roller 305 with its face on which the developer is transferred up.

Further, when the image is formed on both faces of the sheet, the sheet is led from the fixing unit 304 to the path 307 and the path 310. Then, right after the rear end of the sheet passes through the path 307, the sheet is switched back and led to the two-sided conveyance path 309 by the flapper (not illustrated).

The developer is transferred by the transfer unit 306 again onto the sheet led to the two-sided conveyance path 309, and the fixing processing of the developer transferred onto the sheet is performed by the fixing unit 304. As described above, a length of the path, an arrangement of rollers, and a driving system are separately located such that conveyance can be performed, even if five A4 or B5 sheets, for example, are circulating in a round of path from the transfer unit 306 back to the transfer unit 306 again via the two-sided conveyance path 309.

Since, according to the order of discharging the pages by the above-described processing, an odd page is discharged with its face down, the order is set to be the same as a page order for the two-sided copy. A print output product 20 discharged from the sheet discharge roller 305 is conveyed to the print-document reading unit 500.

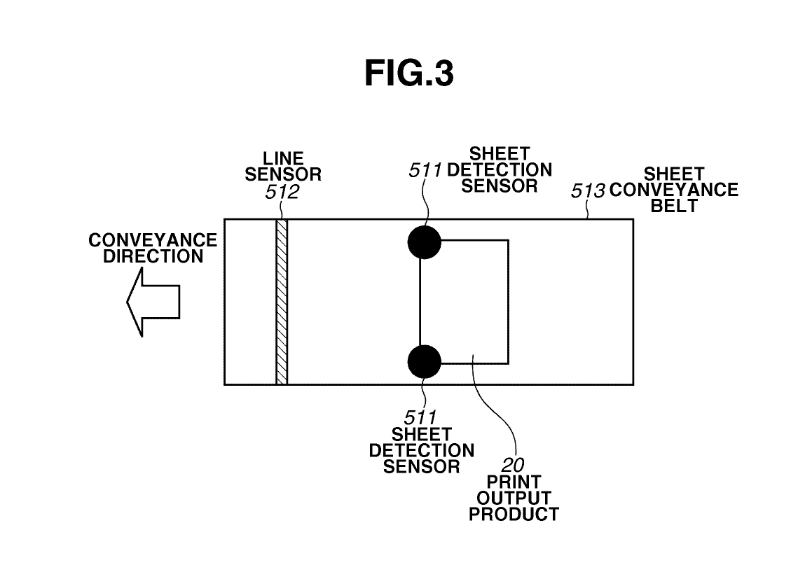

The print-document reading unit 500 includes a print-document reading controller unit 510, a sheet detection sensor 511, a pair of line sensors 512, an inserter controller 514, and an inserter 515. The sheet detection sensor 511 detects a sheet of the print output product 20 that has been conveyed. As illustrated in FIG. 3, the sheet detection sensor 511 detects the sheet with edges of both ends of a sheet on a sheet conveyance belt 513.

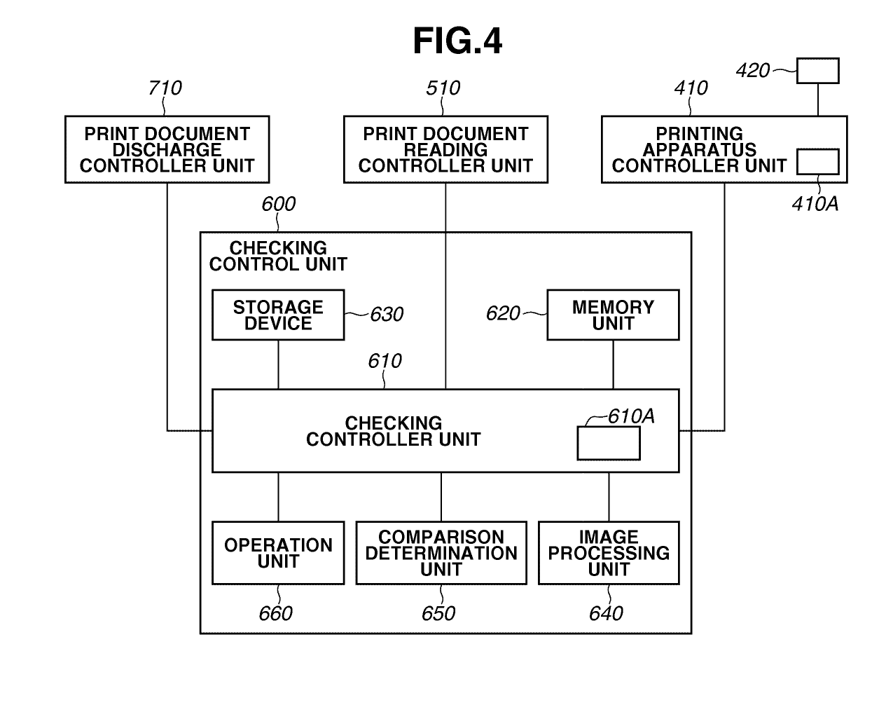

Triggered by a detection signal of the sheet, the print-document reading controller unit 510 controls the line sensors 512 to read the image data of the print output product 20 illustrated in FIG. 3. At this point, an operation of the line sensor is controlled according to a sheet size, one-sided/two-sided, and color/monochrome. For example, when the licensors 512 are disposed above an upper face of the document and below a lower face thereof, and when it is specified to perform the one-sided printing and the sheet discharging with a printed-face down, the print-document reading controller unit 510 controls the line sensors 512 to read the image from the lower face of the document. On the other hand, when the two-sided printing is specified, the print-document reading controller unit 510 controls the line sensors 512 to read the image from the upper face and the lower face of the document. The line sensor of the upper face and that of the lower face are disposed with some shift therebetween in a conveyance direction so that they do not interfere with each other when reading the image. This operation mode is previously instructed for each page from a checking controller unit 610 (refer to FIG. 4).

After the image data is read, the print output product 20 is conveyed to a print-document discharge unit 700, and the reading image data is transferred to the checking controller unit 610. Further, the inserter controller 514 controls the inserter 515 to feed an insertion sheet such as front page sheets and tab sheets according to a user's setting.

FIG. 4 is a block diagram illustrating a configuration of the checking control unit illustrated in FIG. 2.

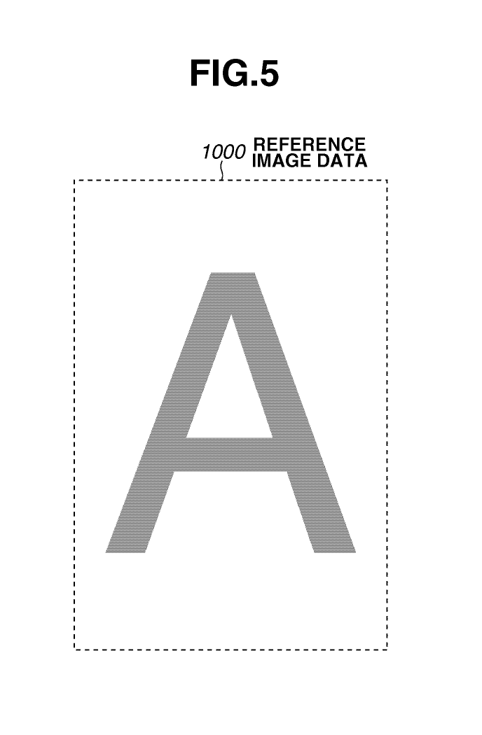

As illustrated in FIG. 4, the checking control unit 600 includes the checking controller unit 610, a memory unit 620, a storage device 630, an image processing unit 640, a comparison determination unit 650, and an operation unit 660. The checking controller unit 610 receives, via the network 3, digital data (reference) of a print image, attribute information about a job, a checking setting value including a threshold value set by the user using the operation unit 200 from the printing-apparatus controller unit 410, and stores them in the storage device 630. An example of reference image data 1000 is shown in FIG. 5.

FIG. 5 is an example illustrating the reference image data 1000 stored in the storage device 630 illustrated in FIG. 4.

As illustrated in FIG. 5, when the print job is received from the general PC 2, for the reference image data, the RIP data obtained by rasterizing the PDL data by the print unit 10 is used. On the other hand, when the copy job is received, the image data read by the image reading unit 100 is used. A reading operation mode of the line sensors 512 is determined based on the attribute information about the job, and instructed to the print-document reading controller unit 510.

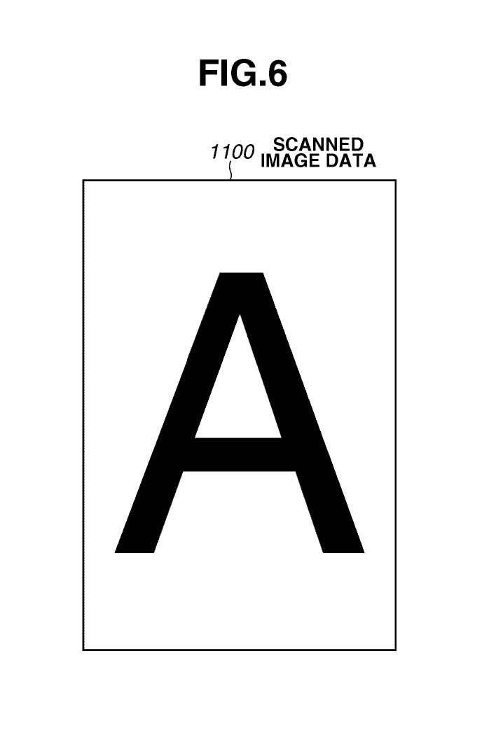

The checking controller unit 610 receives the image data (scanned image data 1100) read by the line sensors 512 from the print-document reading controller unit 510 and stores it in the storage device 630. An example of the scanned image data 1100 is shown in FIG. 6.

FIG. 6 is an example illustrating the scanned image data 1100 stored in the storage device 630 illustrated in FIG. 4.

The image processing unit 640 performs preprocessing for comparing and collating the reference image data 1000 with the scanned image data 1100 read by the print-document reading controller unit 510. More specifically, first, de-screen processing is performed on the reference image data 1000, which is a binary image. This processing is performed so that the reference image data 1000 can have the same gradation as that of the scanned image data 1100, which is a multivalued image.

Second, the image processing unit 640 performs resolution conversion processing on the both images described above. Such processing is performed so that the both images described above can have the same resolution and performance of the comparison and the collation can be improved by reducing the resolution to a sufficient level. Third, the image processing unit 640 performs the image processing of color space conversion processing on the both images described above. Such processing is performed to reflect scanner characteristic of the scanned image data 1100 to the reference image data 1000.

Using the reference data and the scanned image data on which the image processing has been performed, the comparison determination unit 650 compares and collates the images, and then their results are transmitted to the checking controller unit 610. The checking controller unit 610 transmits the received collating result to the printing-apparatus controller unit 410 and the print-document discharging control unit 710.

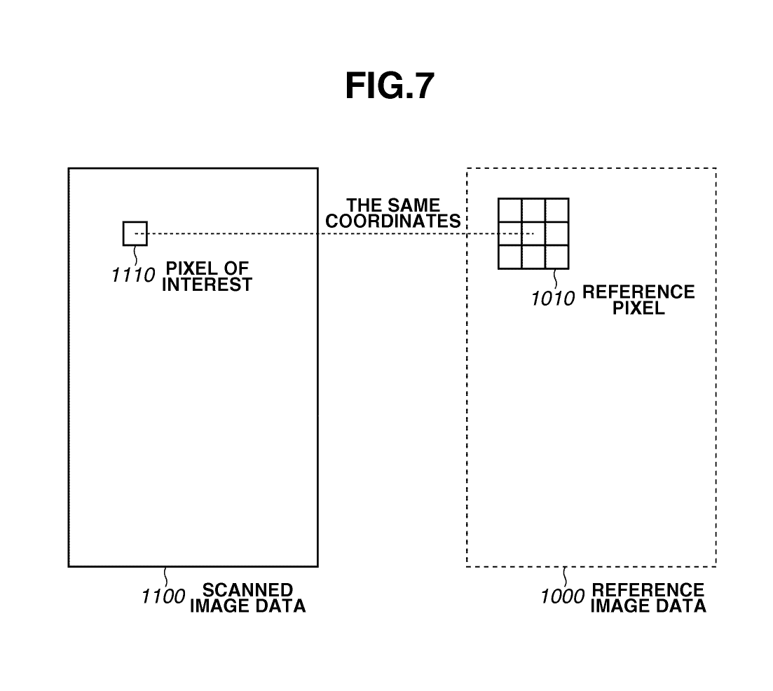

Collation algorithm of the images will be described herein. As illustrated in FIG. 7, one pixel of the scanned image data 1100 is defined as a pixel of interest 1110. The comparison determination unit 650 compares a pixel of interest 1110 with each pixel (reference pixel 1010) included in a square region centered on a same coordinate pixel in the reference image data 1000. When a difference in density between the pixel of interest 1110 and an arbitrary reference pixel 1010 is within a predetermined value, the comparison determination unit 650 determines that the pixel of interest 1110 of the scanned image data 1100 exists in the square region in the reference image data 1000 and thus the pixel of interest 1110 is a right pixel.

When difference data between the pixel of interest and each of all reference pixels 1010 is the predetermined value or more, the comparison determination unit 650 determines that the pixel of interest 1110 of the scanned image data 1100 does not exist in the square region in the reference image data 1000, and thus the pixel of interest is an abnormal pixel. The comparison determination unit 650 performs the above-described collation on all pixels of the scanned image data 1100. Subsequently, if the number of abnormal pixels is a threshold value previously set by the user using the operation unit 660 or less, the comparison determination unit 650 determines that the scanned image data 1100 is “passed”, and if the number thereof is the threshold value or more, the comparison determination unit 650 determines that the scanned image data 1100 is “failed”.

In the print-document discharge unit 700, according to the collating result received from the checking controller unit 610, the print-document discharging control unit 710 controls the discharge of the print output product 20 conveyed to the print-document discharge unit 700.

The finishing unit 800 includes a sheet-discharge separation device 810 and sheet discharge rollers 820, 821. A sheet discharge destination of the print output product 20 conveyed to the finishing unit 800 is switched by the sheet-discharge separation device 810. When the checking determination is “passed”, the print output product 20 is conveyed to a “passed” tray 910 via the sheet discharge roller 820. When the checking determination is “failed”, the print output product 20 is conveyed to a “failed” tray 911 via the sheet discharge roller 821.

The sheet discharge unit 900 detects whether the print output product 20 to be discharged has been discharged by the sheet discharge sensors 901 and 902 in units of pages. If the discharge of the sheet is detected after the checking, the detection thereof is notified to the printing-apparatus controller unit 410.

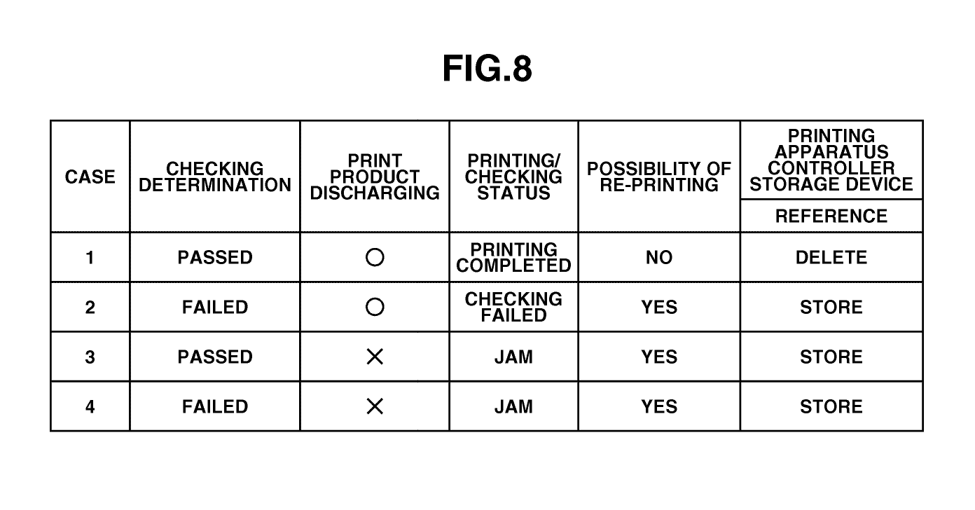

After the printing is performed, the printing-apparatus controller unit 410 notifies, via the network 3, the checking controller unit 610 in the checking control unit 600 of sheet discharge information notified from the sheet discharge sensors 901 and 902. Further, based on the sheet discharge information notified from the sheet discharge sensors 901 and 902, and the collating result transmitted from the checking controller unit 610, the printing-apparatus controller unit 410 controls deletion or storage of the printed print image data stored in the storage device 420. Its control method is shown in FIG. 8.

FIG. 8 illustrates a management method of the print image data by the checking system according to the present exemplary embodiment.

As in a case 1, when it is detected that the checking determination obtained by collating the print output product 20 is “passed” and the print product discharging is detected (∘), the printing-apparatus controller unit 410 determines that re-printing and re-checking of the page is not likely to be performed. Therefore, the printing-apparatus controller unit 410 deletes the printed print image data in the storage device 420.

As in a case 2, when it is detected that the checking determination obtained by collating the print output product 20 is “failed” and the print product discharging is detected, the printing-apparatus controller unit 410 determines that re-printing and re-checking of the page are likely to be performed. Therefore, the printing-apparatus controller unit 410 does not delete the printed print image data in the storage device 420 but stores it.

As in cases 3 and 4, when the print product discharging is not detected (×), since the page has not been printed due to a jam or the like, the printing-apparatus controller unit 410 determines that re-printing and re-checking of the page are likely to be performed. Therefore, the printing-apparatus controller unit 410 does not delete the printed print image data in the storage device 420 but stores it.

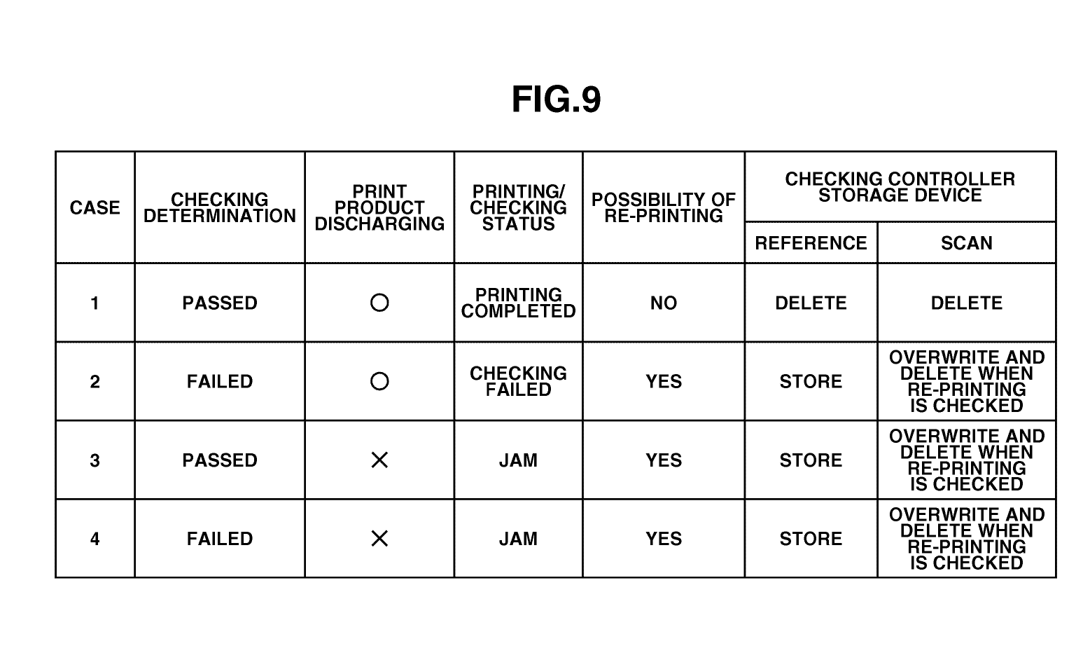

After performing the collation, the checking controller unit 610 controls the reference image data 1000 in the storage device 630 and the scanned image data 1100 based on the sheet discharge information notified from the printing-apparatus controller unit 410 and the collating result by the comparison determination unit 650. Its control method is shown in FIG. 9.

FIG. 9 illustrates a management method of the print image data by the checking system according to the present exemplary embodiment.

As in a case 1, when the checking determination of the print output product 20 is “passed” and the print product discharging is detected (∘), the checking controller unit 610 determines that re-printing and re-checking of the page is not likely to be performed. Therefore, the checking controller unit 610 deletes the printed print image data in the storage device 630, in other words, deletes the reference image data 1000 and the scanned image data 1100. As in a case 2, when the checking determination of the print output product 20 is “failed” and the print product discharging is detected, the checking controller unit 610 determines that the re-printing and re-checking of the page are likely to be performed.

Therefore, the checking controller unit 610 does not delete the reference image data 1000 in the storage device 630 but stores it, and overwrites and deletes the scanned image data 1100 when performing the re-checking. As in cases 3 and 4, when the print product discharging is not detected (×), since the page has not been printed due to a jam or the like, the checking controller unit 610 determines that re-printing and re-checking of the page are likely to be performed. Therefore, the checking controller unit 610 does not delete the reference image data 1000 in the storage device 630 but stores it, and overwrites and deletes the scanned image data 1100 when performing the re-checking.

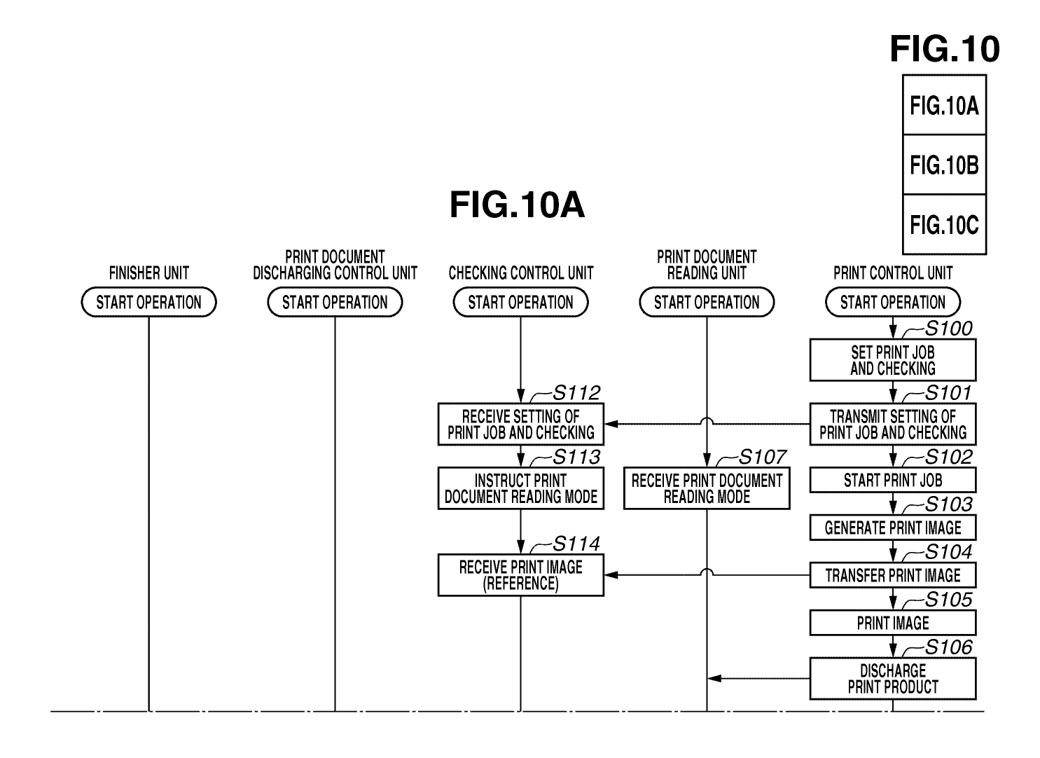

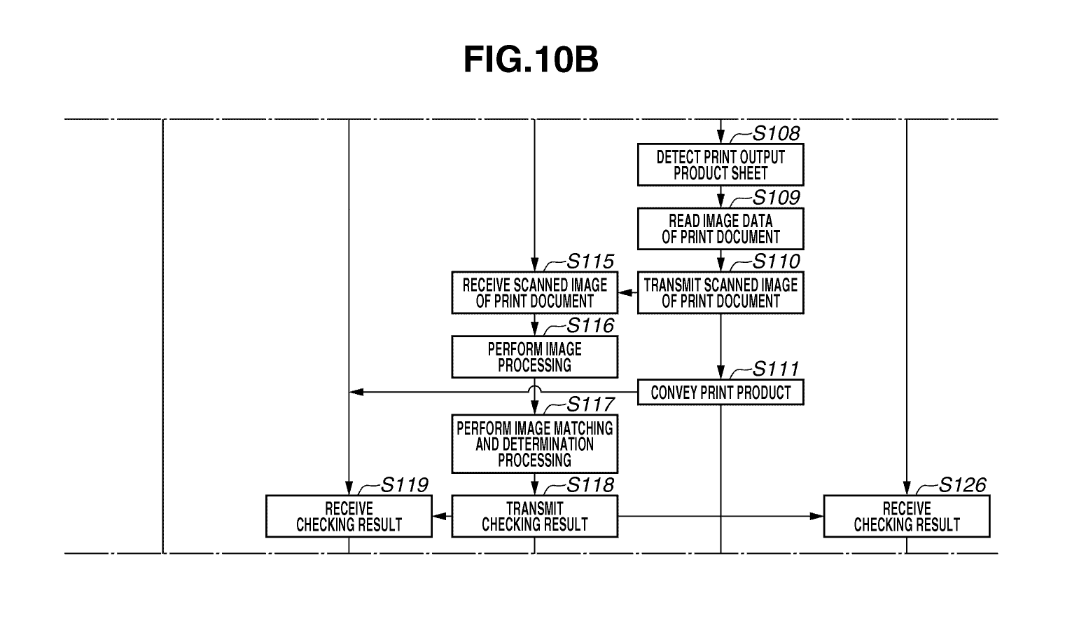

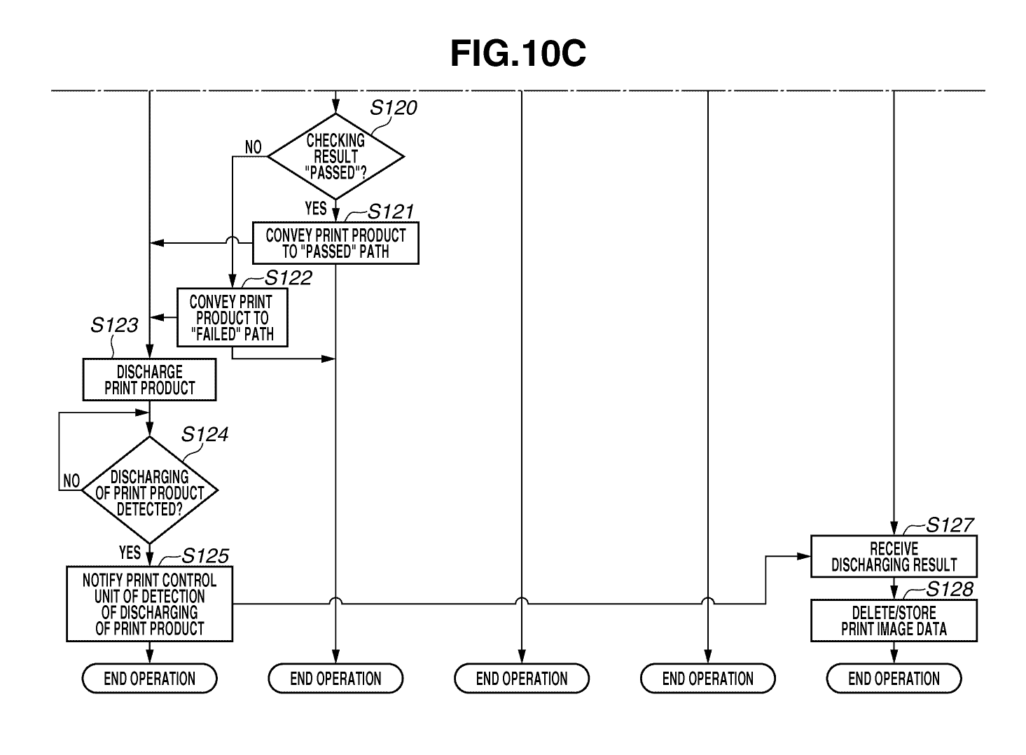

A processing sequence of the print job by the checking system 1 will be described with reference to a flowchart. FIG. 10, composed of FIGS. 10A, 10B and 10C, is a flowchart illustrating the control method of the checking system according to the present exemplary embodiment. The present exemplary embodiment corresponds to a flow from performing the print job to checking and discharging the print product. Each step can be realized when the CPU of each controller of the print unit 10, the print-document reading unit 500, the checking control unit 600, the print-document discharging control unit 710, and the finishing unit 800 loads each control program from the ROM and executes it. The print control unit 400, the print-document reading unit 500, the checking control unit 600, the print-document discharging control unit 710, and the finishing unit 800 will be mainly described below. An example of processing will be described where, based on a checking result received from the checking apparatus and a print product discharging result received from the sheet discharging apparatus, the print control unit 400 deletes the checked print image data from the storage device 410B or stores it in preparation for performing the re-printing. Further, an example will be described where, when re-printing is not performed, the print control unit 400 performs processing for deleting the checked print image data from the storage device 410B, and when the re-printing is performed, the print control unit 400 performs processing for performing printing on the sheet using the print image data stored in the storage device 410B.

In step S100, the user sets the print job (copy job or print job) and its checking by the print control unit 400. The setting of the print job includes the number of copies, color/monochrome, sheet setting, one-sided/two-sided, resolution, and layout. The setting of the checking includes setting a threshold value for passed/failed, and selection of a sheet discharge tray for the “failed”.

In step S101, the print control unit 400 transmits the settings of the print job and of the checking to the checking control unit 600. In step S102, the print control unit 400 starts to perform the print job, and in step S103, the print control unit 400 generates print image data. In step S104, the print control unit 400 transfers the print image data to the checking control unit 600 as the reference image data 1000 for the checking. In step S105, the print control unit 400 prints an image onto a sheet from the print image data generated by controlling an engine, and in step S106, its print product is discharged from the print unit 10 to the print-document reading unit 500.

In step S107, the print-document reading unit 500 receives a reading mode of a print document from the checking control unit 600. In step S108, the print-document reading unit 500 detects a sheet of the print output product 20 discharged from the print unit 10, and in step S109, the line sensors 512 read the image data (scanned image data 1100) of the print document. In step S110, the print-document reading unit 500 transmits the read scanned image data 1100 to the checking control unit 600. Subsequently, in step S111, the print-document reading unit 500 conveys the print output product 20 to the print-document discharging control unit 710, and then ends the operation.

In step S112, the checking control unit 600 receives user settings for the print job and for the checking from the print unit 10, and in step S113, the checking control unit 600 gives an instruction of a print document reading mode to the print-document reading unit 500. Subsequently, in step S114, the checking control unit 600 receives a reference image from the print unit 10, and in step S115, the checking control unit 600 receives the scanned image read by the print-document reading unit 500. In step S116, the checking control unit 600 performs the image processing including the de-screen processing, the resolution conversion processing, and the color space conversion processing on the received reference image data 1000 and scanned image data 1100, and in step 5117, the checking control unit 600 compares and collates the two images with each other. Further, in step S118, the checking control unit 600 transmits the collating (checking) result to the print-document discharging control unit 710, and then ends the operation.

In step S119, when the print-document discharging control unit 710 receives the collating result of the print output product 20 conveyed from the print-document reading unit 500, and in step S120, the print-document discharging control unit 710 switches the conveyance path based on the collating result. At this point, in step S121, the print-document discharging control unit 710 conveys the print output product 20 to a “passed” path if the checking result is “passed”, and in step S122, the print-document discharging control unit 710 conveys the print output product 20 to a “failed” path if the checking result is “failed”, and then ends the operation.

In step S123, the finishing unit 800 discharges the print output product 20 conveyed from the print-document discharging control unit 710. In step S124, the finishing unit 800 detects whether the print output product 20 is correctly discharged by the sheet discharge sensors 901 and 902, and in step S125, the detection result is notified to the print unit 10 to end the processing.

As described above, in steps S126 and S127, the print control unit 400 receives the checking result (passed or failed) from the checking control unit 600 and the print product discharging result from the finishing unit 800. In step S128, based on the checking result and the print product discharging result, the print control unit 400 deletes the printed print image data from the storage device 420 or stores it in preparation for the re-printing to end the processing.

Subsequently, a flow of the management of image data after the checking of the print product and the discharging thereof will be described.

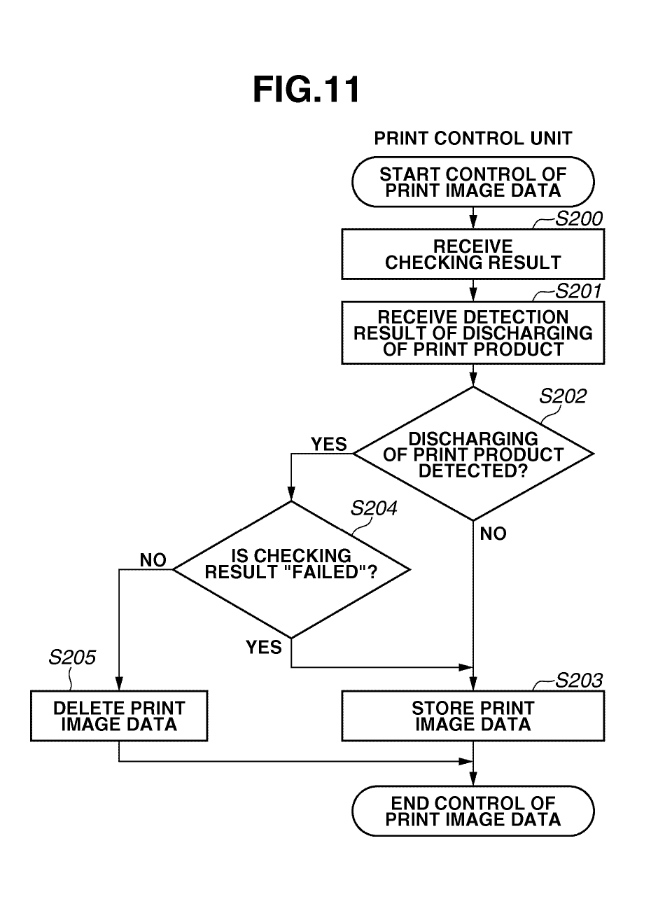

FIG. 11 is a flowchart illustrating a control method of the printing apparatus according to the present exemplary embodiment. The present exemplary embodiment describes an example of image data management processing after the print product is checked and discharged. Each step can be realized when the CPU included in the print control unit 400 loads the stored control program into the memory and executes it. According to the exemplary embodiment, the printing-apparatus controller unit 410 includes a CPU 410A and the checking controller unit 610 includes a CPU 610A.

In step S200, the CPU 410A receives the checking result about a printed sheet from the checking control unit 600 during printing processing. In step S201, the CPU 410A receives a sheet-discharge detection result notified from the sheet discharge sensors 901 and 902 provided for the finishing unit 800. Based on the information described above, the management processing of the print image data temporarily stored in the storage device 420 starts.

In step S202, the CPU 410A judges whether the discharge of the print product has been detected. If the CPU 410A judges that the discharge of the print product has not been detected (NO in step S202), the processing proceeds to step S203. On the other hand, if the CPU 410A judges that the discharge of the print product has been detected (YES in step S202), the processing proceeds to step S204. In step S204, the CPU 410A determines whether the checking result notified from the CPU 610A of the checking controller unit 610 is “failed”. If the CPU 410A determines that the checking result notified from the CPU 610A of the checking controller unit 610 is “failed” (YES in step S204), the processing proceeds to step S203. In step S203, the CPU 410A stores the print image data in the storage device 420 since the re-printing is required, and ends the processing.

On the other hand, if the CPU 410A determines that the discharge of the print product has been detected and the checking result notified from the CPU 610A of the checking controller unit 610 is “passed”, the processing proceeds to step S205. In step S205, since the re-printing is not required, the CPU 410A deletes the print image data of the discharged print product from the storage device 420, and ends the processing.

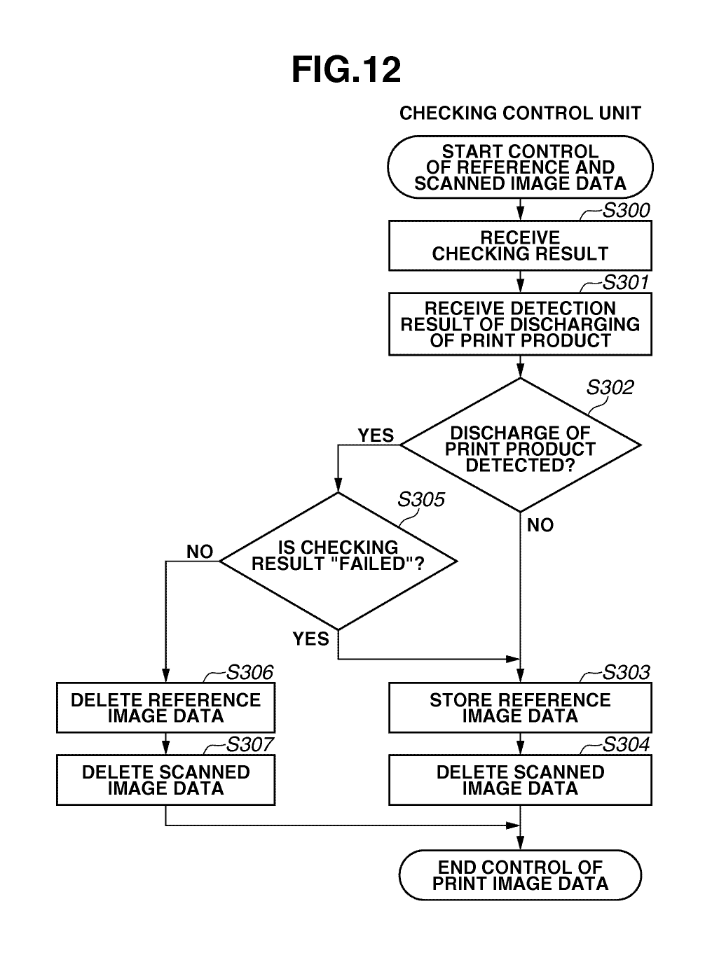

FIG. 12 is a flowchart illustrating a control method of the checking apparatus according to the present exemplary embodiment. The present exemplary embodiment describes an example of the management processing of checking image data by the checking control unit 600. Each step can be realized when the CPU 610A of the checking controller unit 610 included in the checking control unit 600 loads the control program from the ROM and executes it.

In step S300, the CPU 610A of the checking controller unit 610 refers to the checking result of the memory unit 620. In step S301, the CPU 610A receives the sheet-discharge detection result notified from the CPU 410A of the printing-apparatus controller unit 410. Based on the information described above, the CPU 610A starts the management processing of the reference image data and the scanned image data.

In step S302, the CPU 610A judges whether the discharge of the print product has been detected based on the sheet-discharge detection result notified from the sheet discharge sensors 901 and 902. If the CPU 610A judges that the print product has not been discharged based on the sheet-discharge detection result notified from the sheet discharge sensors 901 and 902, the processing proceeds to step S303, and the reference image data is not deleted but kept to be stored in the storage device 630. In step S304, the CPU 610A deletes the scanned image data stored in the storage device 630, and then ends the processing.

On the other hand, in step S302, if the CPU 610A determines that the discharge of the print product has been detected, in step S305, the CPU 610A further determines whether the checking result is “passed” based on the determination result from the comparison determination unit 650. If it is determined that, although the discharge of the print product has been detected, the checking result is “failed” (YES in step S305), the processing proceeds to step S303. In step S303, since the re-checking is required, the CPU 610A keeps the reference image data stored in the storage device 630. In step S304, the CPU 610A deletes the scanned image data stored in the storage device 630, and then ends the processing.

On the other hand, if the CPU 610A determines that the discharge of the print product is detected and the checking result is “passed” (NO in step S305), then in step S306, the CPU 610A deletes the reference image data stored in the storage device 630, since the re-checking is not required. Further, in step S307, the CPU 610A deletes the scanned image data stored in the storage device 630, and then ends the processing.

According to the above-described exemplary embodiment, when the printed print image data (reference image data) and the scanned image data are not required any more, they are deleted. And, when they are required for, for example, the re-printing and the re-checking, they are stored. With this arrangement, security of information about the print image data and the scanned image data can be improved, an amount of storage capacity can be reduced, and performance of an entire system can be maintained. When the CPU 410A deletes the printed print image data (reference image data) from the storage device 420, the deletion may be performed in units of pages or in units of jobs. Further, such unit for the deletion may be previously selected by the user.

According to the present exemplary embodiment, the present invention can be applied to in-line checking processing of the print product including an insertion sheet such as a front page of a booklet. When a great number of copies are printed, only the print product such as the front page of the booklet is printed first. The printing described above is performed to improve printing performance for the entire job, since a thick sheet may be used only for the front page and the color printing may be performed only therefor.

The printed front page is set for the inserter 515, and the entire booklet is printed. For a first page, the front page is inserted from the inserter 515, and for pages following the first page, regular printing is performed. At this point, in addition to the regular print product, to avoid erroneous insertion, the front page is required to be checked.

According to the present exemplary embodiment, the processing flow of the printing and the checking of the insertion sheet is similar to that illustrated in FIG. 10 according to the first exemplary embodiment. And thus, the description will not be repeated.

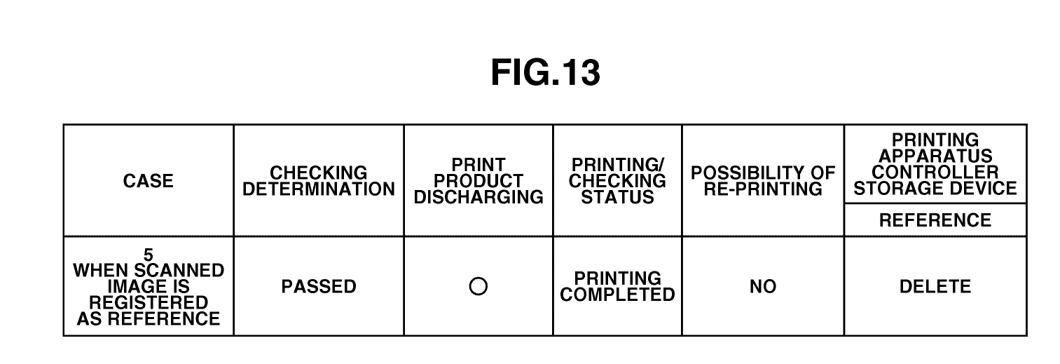

After the insertion sheet is printed and checked, the printing-apparatus controller unit 410 controls digital data of the print image. Such control method is shown in FIG. 13.

FIG. 13 illustrates a management method of the print image data by the checking system according to the present exemplary embodiment.

As illustrated in FIG. 13, as in a case 5, when the scanned image data 1100 is registered into the storage device 630 in the checking control unit 600 as the reference image data 1000, if the collating result of the print output product 20 is “passed” and the print product discharging is detected, it is determined that the re-printing is not likely to be performed. Therefore, the digital data of the print image in the storage device 420 is deleted. A series of processing sequence is illustrated in FIG. 11, and thus is not described herein.

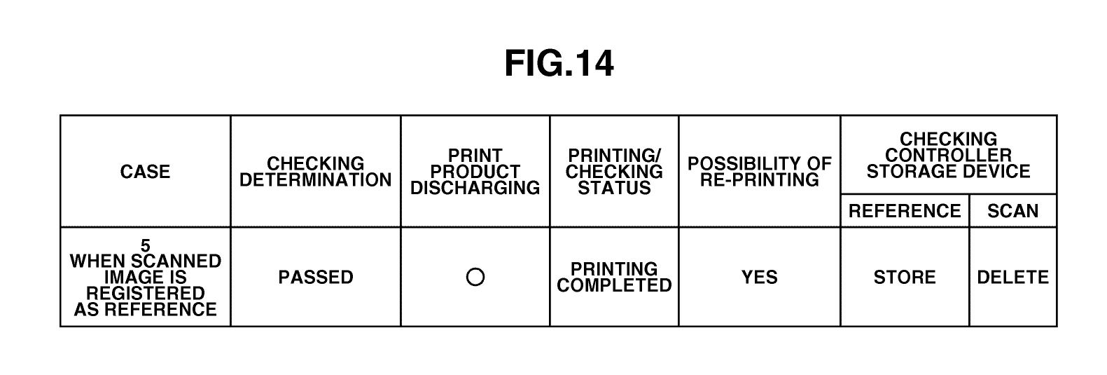

After the insertion sheet is printed and checked, the reference image data and the scanned image data are controlled also by the checking controller unit 610. Such control method is shown in FIG. 14.

FIG. 14 illustrates a management method of the print image data by the checking system according to the present exemplary embodiment.

As illustrated in FIG. 14, since the insertion sheet is also used as the front page for other jobs after the printing is completed, the re-checking is performed to correct orientation of the sheet.

In other words, as in the case 5, the scanned image data 1100 is required to register into the storage device 630 as a reference. Thus, the reference image data 1000 in the storage device 630 is not deleted but stored, while the scanned image data 1100 is deleted. A series of processing sequences is illustrated in FIG. 11.

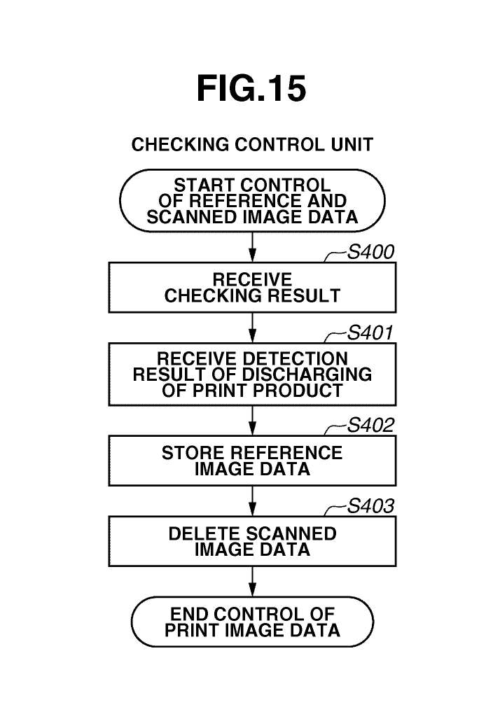

FIG. 15 is a flowchart illustrating a control method of the checking apparatus according to the present exemplary embodiment. The present exemplary embodiment describes an example of the management processing of the checking image data by the checking control unit 600. Each step can be realized when the CPU 610A of the checking controller unit 610 included in the checking control unit 600 loads the control program from the ROM and executes it.

In step S400, the CPU 610A of the checking controller unit 610 refers to the checking result obtained from the comparison determination unit 650, and in step S401, the CPU 610A receives the print product discharging result notified from the sheet discharge sensors 901 and 902. However, since the reference image data 1000 is required for any result described above, then in step S402, the CPU 610A stores the reference image data 1000 in the storage device 630. In step S403, since the scanned image data 1100 is not required, the CPU 610A deletes the scanned image data 1100 from the storage device 630, and ends the processing.

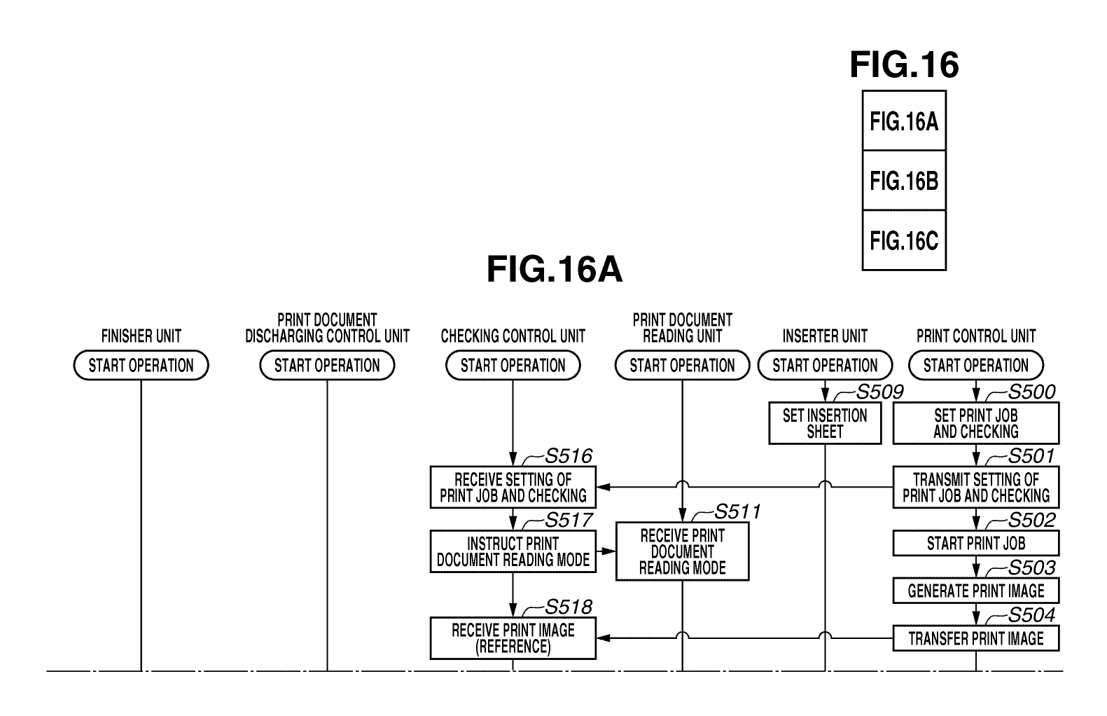

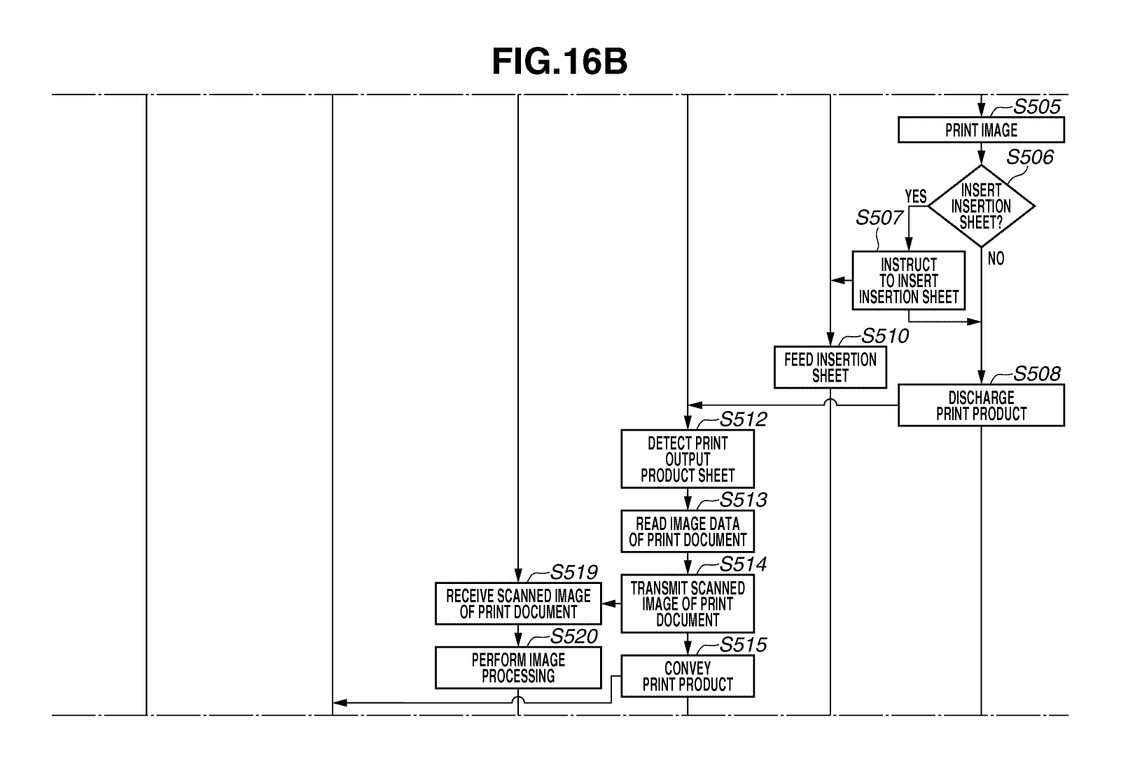

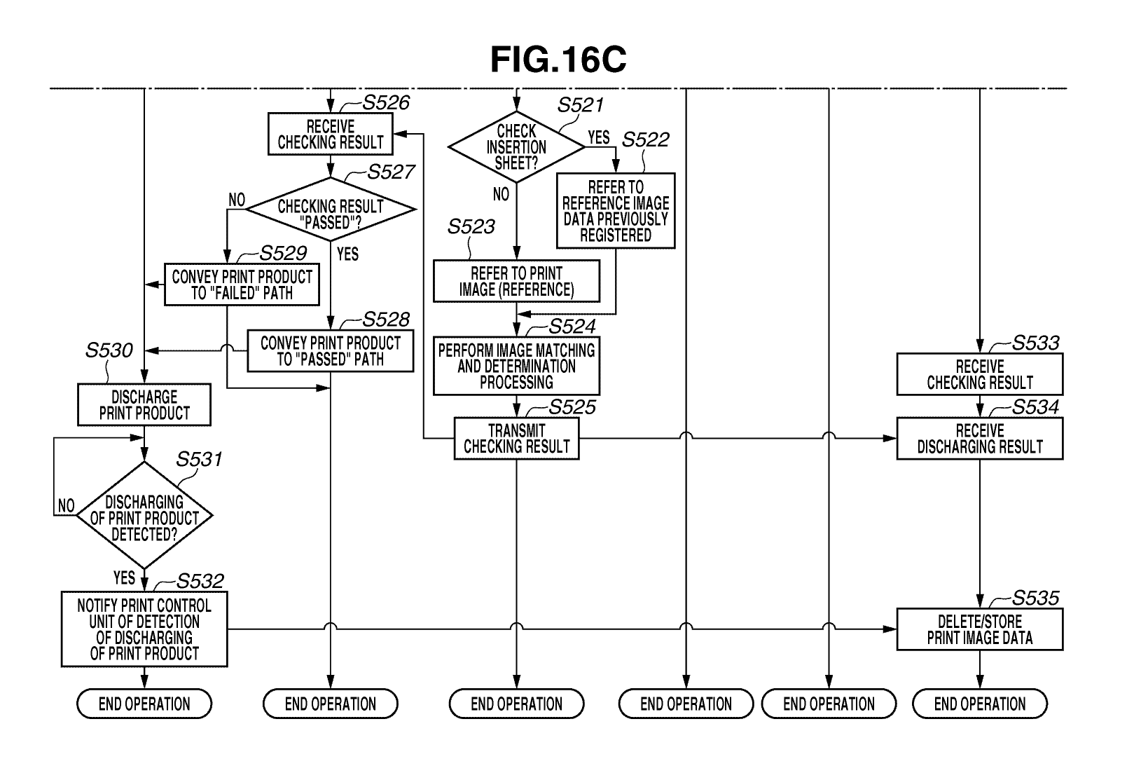

FIG. 16, composed of FIGS. 16A, 16B and 16C, is a flowchart illustrating the control method of the checking system according to the present exemplary embodiment. The present exemplary embodiment corresponds to a flow from execution of the print job for inserting the insertion sheet to the checking and sheet discharging of the print product. Each step can be realized when each controller of the print unit 10, the print-document reading unit 500, the checking control unit 600, the print-document discharging control unit 710, and the finishing unit 800 loads each control program from the ROM and executes it. The print control unit 400, the print-document reading unit 500, the checking control unit 600, the print-document discharging control unit 710, and the finishing unit 800 will be mainly described below.

A difference of FIG. 16 from FIG. 10 described in the first exemplary embodiment will be described.

In step S509, before the print job starts, it is waited that the user sets the insertion sheet such as a front page into the inserter 515.

In step S505, the print control unit 400 controls the engine to print the image data based on the print job. Then, in step S506, the print control unit 400 determines whether the insertion sheet is to be inserted from the inserter 515 based on the setting of the print job. When the print control unit 400 determines that the insertion sheet is to be inserted (YES in step S506), in step S507, the print control unit 400 instructs the inserter 515 to feed the sheet. In step S508, the print product is discharged, and then the print control unit 400 ends its operation.

On the other hand, when the print control unit 400 determines that the insertion sheet is not to be inserted (NO in step S506), then in step S508, the print product is discharged right away in a similar manner to the regular printing, and the processing ends.

In step S510, upon receiving an instruction for inserting the insertion sheet, the inserter 515 feeds the insertion sheet right before the print product. In step S521, along with the feeding of the sheet, the checking control unit 600 determines whether the checking controller unit 610 checks the insertion sheet. When the checking controller unit 610 checks the insertion sheet (YES in step S521), then in step S522, the checking control unit 600 refers to the reference image data that has been previously recorded. When the print product, not the insertion sheet, is checked, in step S523, the checking control unit 600 refers to the reference image data transferred from the printing-apparatus controller unit 410 of the print control unit 400. The difference between the first exemplary embodiment and the present exemplary embodiment is as described above. Other operations are similar to those of the first exemplary embodiment, and thus they are not repeatedly described.

In steps S533 and S534, the print control unit 400 receives the checking result (passed or failed) from the checking control unit 600, and the print product discharging result from the finishing unit 800. In step S535, based on the checking result and the print product discharging result, the print control unit 400 deletes the printed image data from the storage device 420 or the print control unit 400 manages to store the printed image data in preparation for the re-printing to end the processing.

Therefore, when a specific sheet such as a tab sheet or a front page sheet is inserted by the inserter, the print image data (reference) and the scanned image data used to print the specific sheet can be deleted when it is not required, and can be stored when it is required, for example when the re-printing or the re-checking is to be performed. With this arrangement, the security of the information about the print image data and the scanned image data can be improved, the amount of storage capacity can be reduced, and the performance of the entire system can be maintained.

The present invention is not limited to the above-described exemplary embodiments, and variety of modifications (including organic combinations of the exemplary embodiments) of the present invention can be achieved based on the effects of the present invention, and they are not excluded from the scope thereof.

The above-described exemplary embodiments describe a case where, based on the checking state and the print product discharging state that are respectively notified from the checking apparatus and the sheet discharging apparatus, the printing apparatus deletes the printed print image data stored in the storage device. However, based on the print product discharging state received from the sheet discharging apparatus and the checking state, the checking apparatus may output an instruction to the printing apparatus for specifying and deleting the printed image data of the specified page or the job stored in the storage device of the printing apparatus. With this configuration, monitoring works at a controller side of a printing apparatus side can be reduced.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-109037 filed May 11, 2012, which is hereby incorporated by reference herein in its entirety.

What is claimed is:

1. A checking apparatus comprising:
a reading unit configured to read an image printed on a sheet by a printing apparatus;
a storage unit configured to store image data to be compared with the image read by the reading unit;
a determining unit configured to determine whether the image printed on the sheet by the printing apparatus is correct based on the image data obtained by reading the image by the reading unit and the image data stored by the storage unit;
a judging unit configured to judge whether the sheet has been discharged; and
a control unit configured to control deletion of the image data stored in the storage unit based on a determination result by the determining unit and a judging result by the judging unit.

2. The checking apparatus according to claim 1, wherein the control unit, when the determining unit determines that the image printed by the printing apparatus is correct and the judging unit judges that the sheet has been discharged, controls the deletion of the image data stored in the storage unit.

3. The checking apparatus according to claim 1, wherein the control unit, when the determining unit determines that the image printed by the printing apparatus is correct and the judging unit judges that the sheet has not been discharged, controls storage of the image data stored in the storage unit.

4. The checking apparatus according to claim 1, wherein the control unit, when the determining unit determines that the image printed by the printing apparatus is not correct and the judging unit judges that the sheet has been discharged, controls storage of the image data stored in the storage unit.

5. The checking apparatus according to claim 1, wherein the control unit, when the determining unit determines that the image printed by the printing apparatus is not correct and the judging unit judges that the sheet has not been discharged, controls storage of the image data stored in the storage unit.

6. The checking apparatus according to claim 1,
wherein the storage unit further stores the image data obtained by reading the image by the reading unit; and
wherein the control unit, when the determining unit determines that the image printed by the printing apparatus is correct and the judging unit judges that the sheet has been discharged, controls the deletion of the image data to be compared with the image read by the reading unit and the image data obtained by reading the image by the reading unit, both of the data being stored in the storage unit.

7. The checking apparatus according to claim 1, wherein the control unit controls the deletion of the image data stored in the storage unit in units of jobs or units of pages.

8. A control method for controlling a checking apparatus comprising:
reading an image printed on a sheet by a printing apparatus;
storing image data to be compared with the image read by the reading unit in a storage unit;
determining whether the image printed on the sheet by the printing apparatus is correct based on the image data obtained by reading the image and the image data stored by the storage unit;
judging whether the sheet has been discharged; and
controlling deletion of the image data stored in the storage unit based on a determining result and a judging result.

9. A printing apparatus for printing an image on a sheet based on image data, reading the image printed thereon by the printing apparatus, and conveying the image to a checking apparatus for determining whether the image is correct, the printing apparatus comprising:
a memory unit configured to store the image data;
a judging unit configured to judge whether the sheet has been discharged; and
a control unit configured to control deletion of the image data stored in the memory unit based on a determination result by the checking apparatus and a judging result by the judging unit.
